(19) United States
(12) Patent Application Publication
(10) Pub. No.: US 2019/0210746 A1
(43) Pub. Date: Jul. 11, 2019

(54) SYSTEM AND METHOD FOR SPACE OBJECT POSITION DETERMINATION

(71) Applicant: KEPLERIAN TECHNOLOGIES INC., Aldie, VA (US)

(72) Inventors: Robert Thomas FECONDA, Aldie, VA (US); Andrew Michael LONG, Aldie, VA (US); Robert ATKIN, Aldie, VA (US)

(21) Appl. No.: 16/335,121

(22) PCT Filed: Nov. 27, 2017
(86) PCT No.: PCT/US2017/063273

§ 371 Date: Mar. 20, 2019

Related U.S. Application Data
(60) Provisional application No. 62/432,853, filed on Dec. 12, 2016.

(51) Int. Cl. B64G 3/00; G01S 5/10

(52) U.S. Cl. CPC B64G 3/00; G01S 5/10

(57) ABSTRACT

A system for tracking space object includes a plurality of independent, self-powered, commendable beacons, a plurality of ground sensors that are distributed worldwide and receive the beacon's transmission, a centralized command center that provides signal processing, space object position determination, and message generation, and a set of world-wide distributed ground transmission terminals that send commands to the beacons.

### CROSS-REFERENCE TO RELATED APPLICATIONS

This application claims benefit and priority to U.S. Provisional Patent Application No. 62/432,853, filed on Dec. 12, 2016 entitled SYSTEM AND METHOD FOR SPACE OBJECT POSITION DETERMINATION, the disclosure of which is incorporated by reference herein in its entirety.

### FIELD OF THE DISCLOSURE

The present disclosure relates generally to identifying, determining and tracking positions of one or more space objects, and more specifically it relates to a system, a device, a method and a computer program for identifying, determining and tracking positions of one or more space objects.

### BACKGROUND OF THE DISCLOSURE

With the proliferation of space objects (e.g., space capsules, spaceplanes, space stations, satellites, rocket stages, engines, probes, drones, etc.), various space traffic issues (e.g., initial orbit determination, infant mortality, collisions, misappropriation, abandonment, etc. of space objects, or the like) are expected in the near future. The existing approaches to solve these issues rely on remote sensing techniques that require pre-existing object information (e.g., launch, customer/owner, spacecraft features, orbit and the like). The remote sensing techniques are carried out using ground-based systems that either rely on passive optical sensors (e.g., telescopes) or active sensors (e.g., radar, lasers, or the like) to detect space objects and determine their positions. Due to the sophistication and size limitations, a limited number of active sensors are sparsely located around the world, which limits the ability of these systems to provide frequently updated space object positions. Furthermore, these systems focus on a single space object at a time, which limits their ability to carrying out continual updates to an ever-growing space object population. In addition, the ability of remote sensing systems to detect, track, and identify space objects becomes more limited as the space objects get smaller in size and operate in close proximity of other objects (e.g., satellite swarms, multiple secondary payload deployment). Hence, the ground-based systems are not capable of finding and tracking small-sized spacecraft units (e.g., CubeSat or the like) that are currently being employed.

Accordingly, there is a need for a system, a device, a method and a computer program for accurately and reliably determining and tracking positions of space objects in real-time, or near real-time.

### SUMMARY OF THE DISCLOSURE

According to one aspect of the present disclosure, a system for tracking one or more space objects may include one or more independent, self-powered, commandable beacon devices; a sensor network having a plurality of ground sensors that are distributed geographically and receive transmissions from the one or more beacon devices; a centralized command center that provides signal processing, space object position determination, and message generation; and a set of geographically distributed ground transmission terminals that send command signals to the beacon devices.

The beacon device may comprise a microprocessor, data storage, power supply, and a transceiver. The beacon device may further allow for connectivity to an external power supply. The microprocessor may be configured to generate or receive a unique identification code signal and/or a beacon data signal, including beacon metadata. The microprocessor may be configured to receive a control signal. The control signal may include transmission scheduling instructions, timing synchronization, and meta-data for use by the beacon device and/or host space object. The microprocessor may be further configured to receive a data signal from a host space object on/in which the beacon device may be provided, wherein the beacon data signal may include host metadata.

The sensor network may comprise a plurality of ground sensors that are distributed geographically and receive transmissions from the one or more beacon devices. The sensor network may comprise a plurality of ground sensors distributed geographically, each of which may be communicatively coupled to other ground sensors within the sensor network. The sensor network may be communicatively coupled to the centralized command center via one or more communication links.

Each ground sensor may comprise a processor, memory storage, and a global positioning satellite (GPS) receiver. The ground sensor may comprise an antenna. The ground sensor may comprise a transmitter or a transceiver. The ground antenna is configured to receive beacon transmission signals. The GPS receiver is configured to receive and process GPS signals. The onboard processor processes the received beacon transmission signals and GPS signals. When a beacon transmission is collected, the onboard processor captures the receive time, frequency and duration of the beacon transmission. The onboard processor extracts the unique identification code from the beacon transmission to associate the transmission to the originating beacon, and thereby the space object. The onboard processor may utilize GPS signals to synchronize time across the ground sensor network and/or determine the precise near-real time location of the ground sensors and the precise timing of the beacon signal receipt at that ground sensor. Based on the determinations made, the onboard processor may generate a sensor data signal comprised of the raw beacon transmission, signal reception meta-data (receive time, frequency and duration), GPS signal, GPS computed position of the ground station and/or GPS timing. The processors will instruct the onboard transceiver to transmit the sensor data signal to the centralized command center. The transmission may be via a network connection (such as, e.g., an Internet connection), either hardwired from the facility the ground sensor is located at or via a wireless signal (such as, e.g., a cellular signal, a satellite signal, a WiFi signal, or the like).

The command center may receive sensor data signals from the sensor network and provides signal processing, space object position determination, and message generation based on the sensor data signals. The command center may include a database, or it may communicate with an externally provided database. The command center may comprise one or more processors, data storage, and a transceiver. The command center processor may correlate sensor data signals to an individual beacon and may utilize a variety of positioning techniques to determine real-time or near-real-time Euclidean space coordinates (r,Θ,ϕ), Cartesian space coordinates (x,y,z), or the like, for the beacon device(s), and thereby the space object, from which the beacon transmission signals originated. The command center processors will also process both beacon sensor meta-data and/or space-object meta-data. The command center may further comprise a user input/output interface (UIOI) such as, for example, a keypad, a mouse, a touchscreen, a speaker, a microphone, a voice recognition module, or the like, and/or a graphic UIOI such as, for example, a display. The command center may be configured to receive the sensor data signals, analyze the received data signals, determine real-time or near-real-time positions of space objects based on the received sensor data signals, generate a space object report signal, and send one or more space object report messages to an external computer device, database, or network-interface. The space object report signal may include time data, beacon device identification data, beacon sensor meta-data, space object identification data, space object meta-data, position data, and the like. The meta-data may include sensor data, such as, for example, body rates, accelerations, and like.

The command center may comprise a beacon position determiner, a host metadata processor, a beacon metadata processor, a coarse orbit determiner, a fine orbit determiner, a message generator, a message disseminator, and a beacon transmission scheduler. The message disseminator may send the space object report signal to the external computer device. The beacon transmission scheduler may generate and send transmission scheduling data, which may be sent to one or more beacon devices to control timing of transmissions from the beacon devices.

The database may comprise external orbit ephemeris data, beacon device data, space object data, external computer device data, ground sensor location data, antenna data, and the like.

In one aspect, a method is provided for position, orbit determination, and unique identification of space objects using an independent, self-powered, command-able beacon that is placed upon a space object and transmits a signal composed of a unique identification code, along with meta-data generated by the beacon. Direct and unique space object identification may be achieved by receipt of a beacon's unique identification code. The method may provide for position, orbit determination, and unique identification of space objects even in the event of failed deployment, operational failure, and or space object decommission. The method may provide for position, orbit determination, and unique identification of non-operational space objects, such as non-functioning spacecraft, rocket bodies, upper stages, rocket engines, and debris. Data transmissions from on-orbit beacons may be received through a worldwide set of networked ground sensors and/or space-based relay satellites. A distributed ground sensor network may be utilized to spatially locate the beacon transmission, thereby determining the position of the beacon and host space object. The distributed ground sensor network may determine the time, frequency, and duration of the beacon transmission signals for determining the position of the beacon and the host space object. The beacon unique identification code may be used to correlate transmissions received by the distributed ground sensor network. The data transmission may use one or more static or dynamic communication scheduling techniques in order to allow for multiple and simultaneous beacon transmissions. Coarse space object position and orbit determination may be computed using signal geolocation techniques. Fine space object position and orbit determination may be computed through fusion of coarse space object position data along with various external space object data sets.

In one aspect, a system for tracking space objects includes a plurality of independent, self-powered, commandable beacons, a plurality of ground sensors that are distributed worldwide and receive the beacons transmission, a centralized command center that provides signal processing, space object position determination, and message generation and a set of world-wide distributed ground transmission terminals that may send commands to the beacons. At least one of the ground sensors may utilize GPS receivers in order to provide accurate ground station positioning and timing. At least one of the ground sensors may utilize fixed spatial sampling techniques in order to refine a feasible position solution set. At least one of the ground sensors may utilize scanning spatial sampling techniques in order to refine a feasible position solution set.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system for tracking space objects, constructed according to the principles of the disclosure;

FIG. 2 shows another example of the system for tracking space objects, constructed according to the principles of the disclosure;

FIG. 3 shows an example of a beacon device, constructed according to the principles of the disclosure;

FIG. 4 shows an example of an operation of the beacon transmitter device in FIG. 3, according to the principles of the disclosure;

FIG. 5 shows an example of a ground sensor device, constructed according to the principles of the disclosure;

FIG. 6 shows an example of an operation of the ground sensor shown in FIG. 5, according to the principles of the disclosure;

FIG. 7 shows an example of a command center computer, constructed according to the principles of the disclosure; and

FIG. 8 shows an example of an operation of the control center computer shown in FIG. 7.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

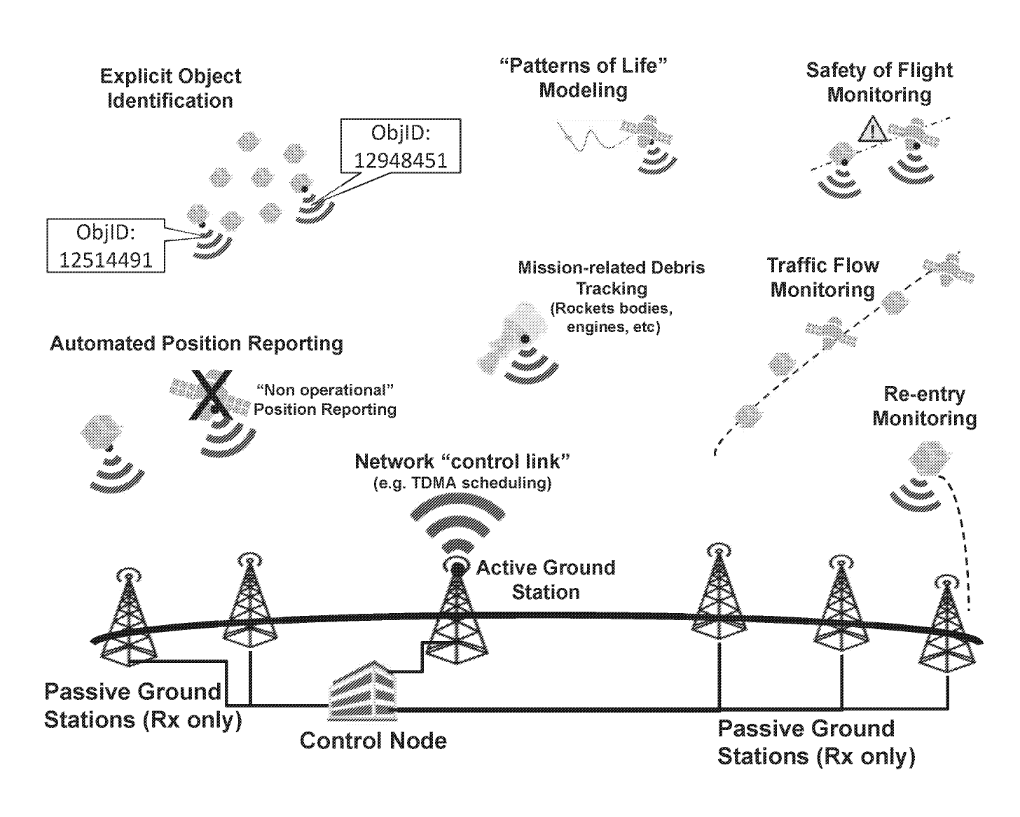

FIG. 1 illustrates an example of a system 100 for detecting and tracking space objects, constructed according to the principles of the disclosure. The system 100 may carry out various operations, such as, for example, explicit object identification, automated position reporting, mission-related debris tracking, safety-of-flight monitoring, traffic flow monitoring, re-entry monitoring, “patterns of life” monitoring, and/or the like, of a number of space objects, as seen in FIG. 1. The system 100 may utilize a mountable or installable beacon device having unique identification information for determining and tracking each individual beacon device and, thereby, associated space object. The system 100 may include a combination of, for example, in-space “space object beacons” and automated, low-cost ground collection sites, which may provide near-real time 24/7 space situational awareness (SSA), explicit in-depth space object identification, space object behavior monitoring, and/or the like. For example, the system 100 may be utilized for detecting, identifying and tracking space satellites using radio frequency signals.

The system 100 may utilize a mountable/installable beacon device (hereinafter “beacon”) having unique identification information for determining and tracking each individual space object. For example, each space object may be provided with a beacon that may be highly miniaturized thus applicable to even a single CubeSat (10×10×11.35 cm) or segments thereof (e.g. 10×10×2 cm) without significant mission impact. Since each space object may be provided with a beacon transceiver (including, e.g., a receiver and a transmitter), the system 100 may operate without external position information (e.g., Global Positioning System (GPS) data or the like) on the host space object. The beacon may be self-powered and operate independently from the host space object. Therefore, the beacon may survive and continue to operate after the useful mission life of the host space object. Additionally, the system 100 may be placed upon non-operational space objects such as rocket bodies, upper stages, and rocket engines. The system 100 may operate continuously or at some preset or commanded frequency in near-real time with no constraints to lighting, visibility or other conditions.

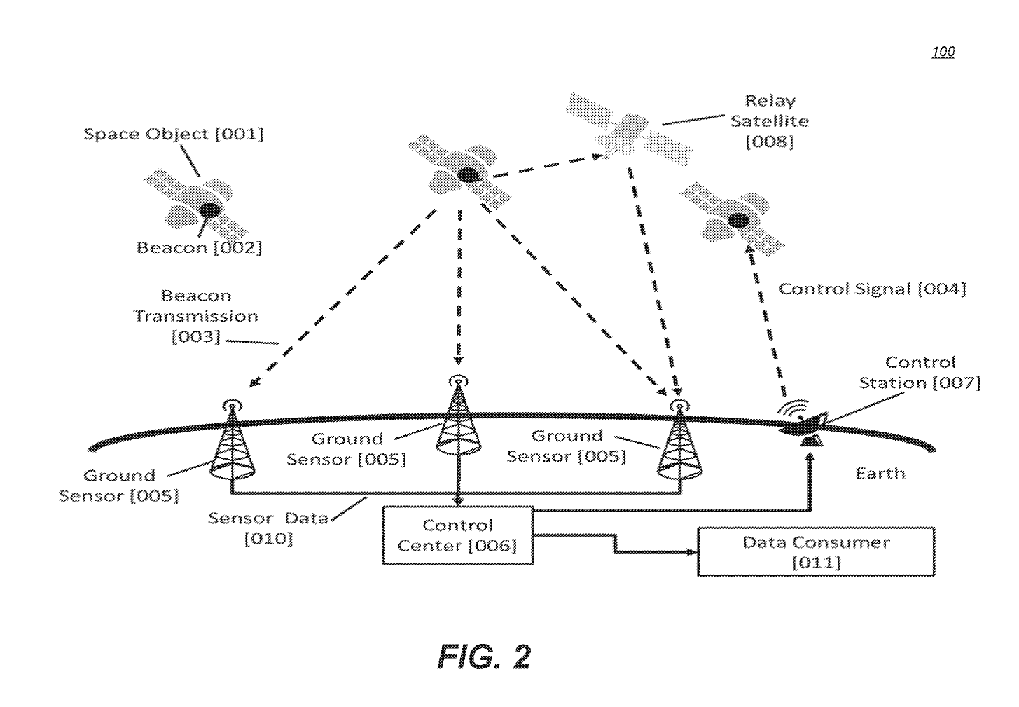

FIG. 2 illustrates another example of the system 100 for detecting, identifying and tracking space objects, which is constructed according to the principles of the disclosure. The system 100 may include, for example, a plurality of beacons [002], a plurality of ground sensors [005], a command center [006], a set of ground transmission terminals [007], and/or the like.

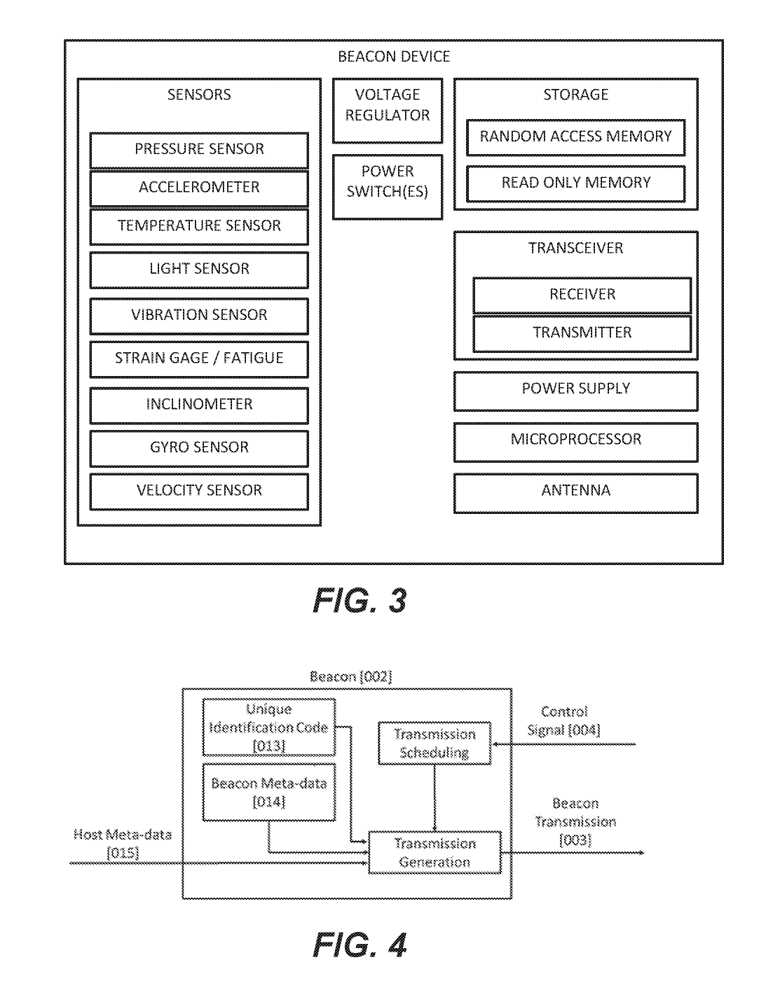

The beacons [002] may operate independently from each other, remotely operated and may be self-powered. Each beacon [002] may be mounted to a corresponding space object [001]. The ground sensors [005] may be distributed geographically such as, for example, globally (i.e., worldwide) or regionally (e.g., continent, subcontinent, country, etc.). The ground sensors [005] may be configured to receive data transmission signals from the beacons [002]. The command center [006] may be a centralized data processing center for, for example, signal processing, space object position determination, message generation, and/or the like. The set of ground transmission terminals [007] may be distributed globally or regionally and may send a control signal [004] (shown in FIG. 3) to the beacons [002]. The ground sensors [005] may include GPS receivers to provide accurate ground station positioning and timing. At least one of the ground sensors [005] may utilize fixed spatial sampling techniques or scanning spatial sampling techniques, in order to refine a feasible position solution set.

FIG. 3 shows an example of a beacon, constructed according to the principles of the disclosure. The beacon comprises a microprocessor, a power supply, a transceiver, data storage and one or more sensors. The power supply may include a battery, a solar panel, an atomic power source, or the like. The transceiver comprises a receiver and a transmitter. The transceiver may include an antenna. The storage comprises a random access memory (RAM) and a read only memory (ROM). The one or more sensors may comprise a pressure sensor, an accelerometer, a temperature sensor, a light sensor, a vibration sensor, a frame strain gage or fatigue sensor, an inclinometer, a gyroscopic sensor, a velocity sensor, and/or the like.

According to another aspect of the disclosure, the beacon device may be provided with only a transceiver, microprocessor, power supply, data storage and accelerometer, so as to provide a small structure, parts (or the whole) of which may be made with nanocomponents.

According to the disclosure, the beacon [002] may include, for example, a accelerometer/gyro unit for the accelerometer and gyroscopic sensor for attitude knowledge. The beacon may generate and transmit real-time or near-real-time information related to the space object, including changes to the object's velocity. The beacon may further include a voltage regulator and one or more power switches. The microprocessor may be comprised of a radiation tolerant microcontroller unit. Since the beacon [002] may consume very low power, the beacon [002] may be powered by an internal battery, a miniaturized solar panel attached thereto, and/or an external power from the host space object [001].

The system 100 may carry out detecting, identifying and tracking the beacons [002] mounted on or in the space objects [001. Referring to FIG. 4, each beacon [002] may generate and transmit a beacon transmission signal [003], which may contain, for example, a unique identification code [013], sensor data, metadata [014] generated by the beacon [002], and/or the like. The beacon transmission signal [003] may also include metadata [015] provided by the host space object [001]. The beacon [002] may also receive the control signal [004] from the ground transmission terminals [007]. The space object [001] may be identified by the unique identification code [013] of the corresponding beacon [002], data messages [015] and/or the like, included in the beacon transmission signal [003] received by the ground sensors [005]. The beacon [002] may transmit the beacon transmission signal [003] even in the event of failed deployment, operational failure, space object decommission, or the like. The beacon [002] may also schedule transmission of the beacon transmission signal [003] based on the control signal [004]. The beacon signal may use one or more forms of transmission scheduling/spectrum management techniques such as Time-Division Multiple Access (TDMA), Frequency-Division multiple access (FDMA), and Code Division Multiple access (CDMA), or the like, allowing for transmission, collection, processing, and position determination of one or more beacons simultaneously.

Referring to FIGS. 3 and 4, the beacon device may include one or more sections of computer programming code on a computer readable medium that, when executed by the microprocessor, carries out the process shown in FIG. 4.

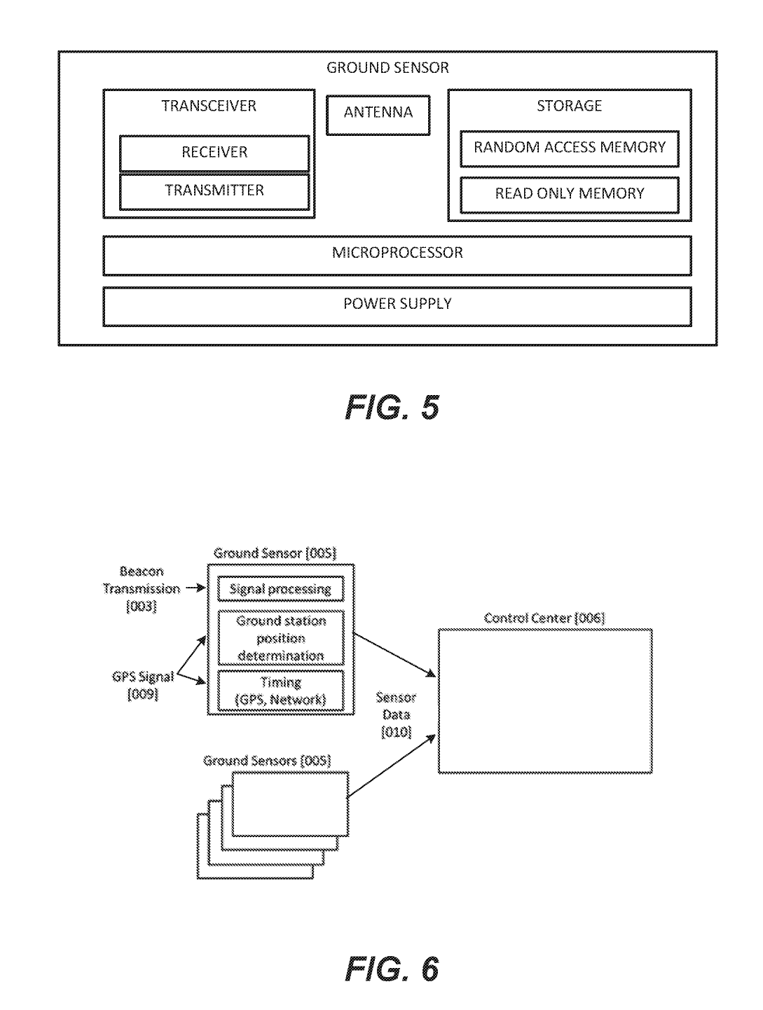

FIG. 5 shows an example of a ground sensor that is constructed according to the principles of the disclosure. The ground sensor includes a microprocessor, data storage, a transceiver, GPS receiver, and a power supply. The ground sensor may further include an antenna. The transceiver comprises a transmitter and a receiver. The storage may comprise a RAM and/or a ROM. The power supply may comprise an electrical connection to an external power supply, a battery, a solar panel, a wind turbine, or the like.

Referring to FIG. 6, the distributed ground sensor network [0005], space-based relay satellites, and/or the like, may receive the beacon transmission signals [003] from the beacons, as well as a GPS signal [009], and/or the like. The distributed ground sensor network [005] may determine the time, frequency, and duration of the beacon transmission signals [003] for determining the position of the beacon [002] and the host space object [001]. The identification code [013] included in the beacon transmission signal [003] may be used to correlate transmissions received by the distributed ground sensor network [005].

Referring to FIGS. 5 and 6, the ground sensor may include one or more sections of computer programming code on a computer readable medium that, when executed by the microprocessor, causes the process shown in FIG. 6 to be carried out.

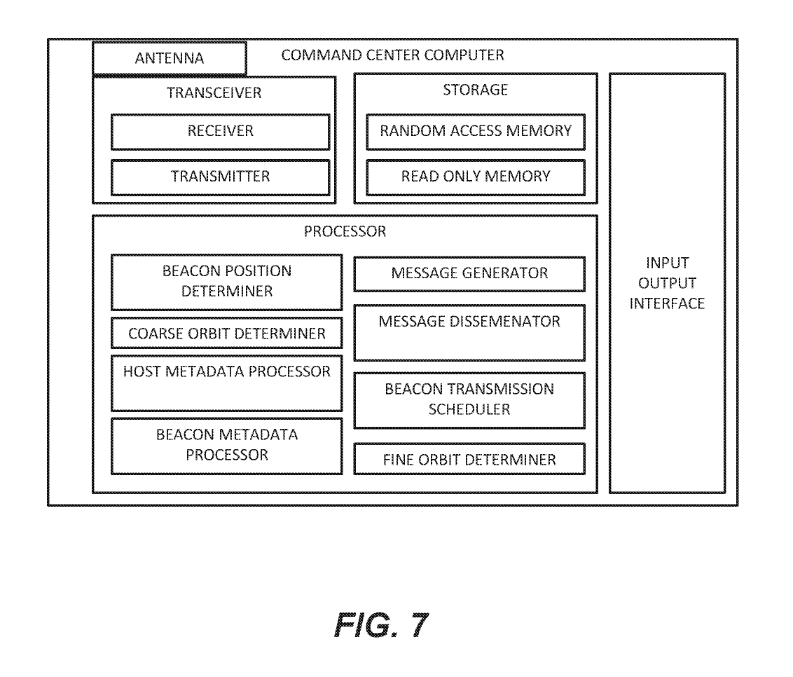

FIG. 7 shows an example of a command center computer that may be included in the centralized command center. The command center computer comprises one or more processors, a transceiver, storage and an input/output interface (IOI). The transceiver comprises a transmitter and a receiver. The storage may comprise a RAM, ROM, and the like. The processor comprises a beacon position determiner, a coarse orbiter determiner, a host metadata processor, a beacon metadata processor, a message generator, a message disseminator, a beacon transmission scheduler, and a fine orbit determiner. The various components in the processor may be provided as hardware, software, or a hybrid of hardware and software. For instance, each of the components in the processor may be provided a software module, an application specific integrated circuit (ASIC), or the like.

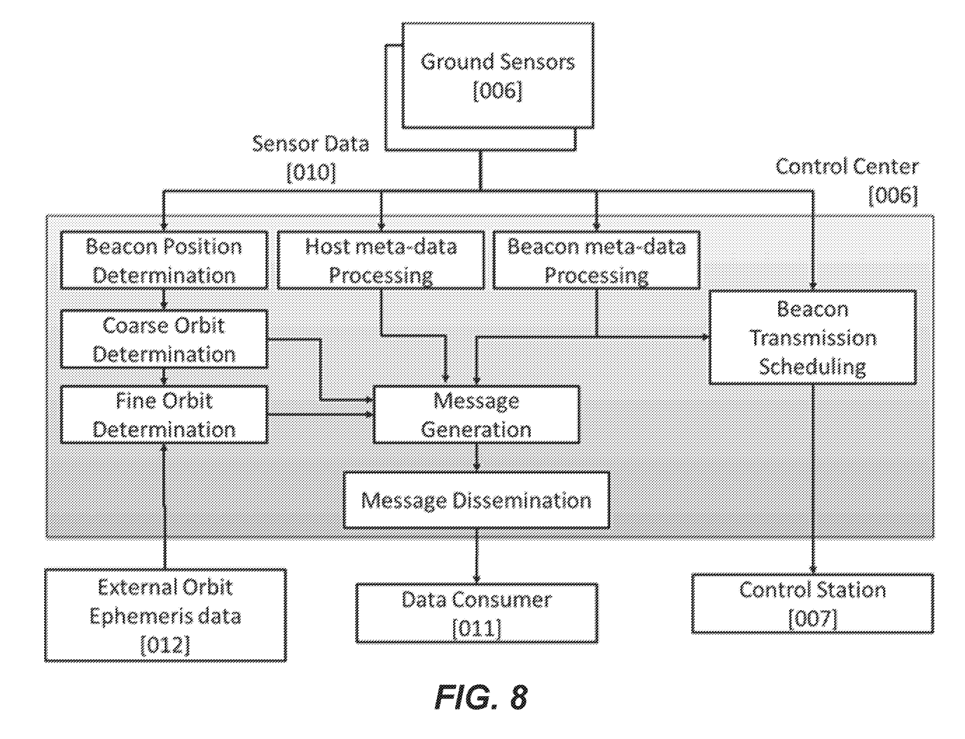

FIG. 8 shows an example of an operation of the command center computer, according to principles of the disclosure. Referring to FIG. 8, the distributed ground sensor network [005] may provide sensor data [010] to the control center [006]. Based on the sensor data [010], the control center [006] may perform beacon position determination, host meta-data processing, and beacon meta-data processing. Based on the beacon position determination, the control center [006] may perform coarse orbit determination. The control center [006] may then perform fine orbit determination of the beacon [002] based on, for example, the coarse orbit determination result, external orbit ephemeris data [012], and/or the like. The coarse space object position and orbit determination may be computed using, for example, signal geolocation techniques such as Angle of Arrival (AoA), Time of Arrival (TOA), Time Difference of Arrival (TDOA), Frequency Difference of Arrival (FDOA), Cross TDOA/FDOA ambiguity, and/or the like. The fine space object position and orbit determination may be computed through, for example, fusion of the coarse space object position data along with various external space object data sets [012]. Fine space object positioning may also be obtained through repeated tracking orbits using one or more of the aforementioned techniques.

The command center computer in the control center [006] may determine the coarse and fine orbit information based on the host meta-data processing, the beacon meta-data processing, and/or the like. The control center [006] may then disseminate a message to a data customer user [011]. The control center [006] may generate beacon transmission scheduling data based on, for example, the sensor data [010], the beacon meta-data processing, and/or the like, and provide the beacon transmission schedule data to the control station [007], which may, in turn, transmit the control signal [004] to the beacon [002].

According to the disclosure, the space object [001] may be positively identified at any time by the unique identification code transmitted by the corresponding beacon [002]. Such placement of a “space object beacon” may provide immediate object identification through the transmission of the unique identification code [013]. The beacon [002] may be configured to automatically, continuously and regularly transmit the beacon transmission signal [003] at a short interval throughout its operational lifetime. The beacon transmission signal [003] may be received only by the distributed ground sensor network [005], which may provide a means for 24/7 continuous SSA and avoid the operational constraints of the existing ground-based sensing systems.

The system 100 may not need or use a ground-based identification system, and hence may identify a space object that is virtually invisible to ground-based systems. The beacons [002] may be manufactured to be small, and this may allow the beacons [002] to be proliferated across a wide range of space objects (e.g., large, medium, small, CubeSat-sized or smaller spacecraft rocket bodies, upper stages, or the like). Multiple beacons [002] may be deployed for a single launch event or a single space object.

The beacon [002] may be self-powered, which may allow it to operate independently from the host space object [001]. Thus, the beacon [002] may operate well beyond the operational life of the host space object [001], thereby providing real-time monitoring of space traffic during and after mission life. This may be beneficial to the SSA community in the case of CubeSat pre-deployment failures, infant mortality, or the like, which may result in a non-functional space object in orbit for years or decades. An operational period of the beacons [002] may be less 5 years, or may exceed 10 years with careful part selection and design considerations, and, therefore, can be matched to the orbit regime of the host object, as appropriate. The independent power source may allow the beacons [002] to be placed on mission-related satellite debris (e.g., rocket bodies, upper stages, or the like), which currently [circa 2015] comprise about 10% of all space debris (approximately 2000 objects), which is a half the number of on-orbit spacecraft units.

The beacon transmission signal [003] may include additional meta-data (e.g., accelerations, lighting, etc.), which may aid in space object position determination and provide more in-depth characterization of the host space object [001], which may not be obtained by remote sensing. The beacon [002] may be connected to and integrated with the host space object [001] via a standard wired interface (e.g., RS422, Spacewire, MilStd 1553, etc.) to transmit health and safety information of the host space object [001] along with the standard identification message [013] of the beacon [002]. Such additional information may be provided to the customer [011] as a 24/7 system health and status monitoring data.

Referring to FIGS. 7 and 8, the command center computer may include one or more sections of computer programming code on a computer readable medium that, when executed by the processor, causes the process shown in FIG. 8 to be carried out.

The system provided herein provides multiple advantages, such as, for instance:
Explicit space object identification: Current SSA solutions utilize remote sensing and data correlation to infer an object's unique identification. Placement of a “space object beacon” will provide immediate object identification through the transmission of unique ID codes.
24/7 Space Situational Awareness: space object beacons are designed to transmit continuously or on short intervals throughout their operational lifetimes. The collection of these continual transmissions by proliferated, automated, low-cost receive only ground stations provides a means for 24/7 SSA and avoids the traditional operational constraints of ground-based sensing systems.
Independent of space object size/quantity: The ability of remote sensing systems to detect, track, and identify space objects becomes more difficult as the objects get smaller in size and/or operate in close proximity of other objects (i.e. satellite swarms, multiple secondary payload deployment). The system avoids these challenges by directly attaching a beacon to the space object.
Small form factor: The small size of the space object beacons allows them to be proliferated across a wide range of space objects (Large- medium- small- and cube-sats, rocket bodies, upper stages, etc.). Multiple beacons may be deployed for a single launch event. Multiple beacons may be deployed on a single space object.
Self-powered: The self-powered nature of the space object beacons allows them to operate independently of the host space object. Thus, the beacons can operate well beyond the operational life of the space object—providing real-time monitoring of space during and after mission life. This has particular value to the SSA community in the case of CubeSat pre-deployment failures/infant mortality which might leave a non-functional CubeSat in orbit for several years—possibly decades. The independent power source allows these devices to be placed on mission-related satellite debris (i.e. rocket bodies, upper stages) which currently [circa 2015] comprise roughly 10% of all space debris (approx. 2000 objects)—half the number of on-orbit spacecraft.
In-depth object characterization: “Space object beacons” generate additional meta-data (e.g. accelerations, lighting) from the beacon's internal components which can provide more in-depth characterization of the space object than remote sensing can provide. Furthermore, the system may include the option to integrate with the host space object through a standard wired interface to allow the beacon to transmit space object generated health and safety along with the beacon's standard identification message if desired by the customer. Not only would this allow for even more in-depth space object characterization that cannot be attained through remote sensing means, but it provides a 24/7 health and status monitoring capability that we believe would be highly valued by all spacecraft operators. This spacecraft data would be in addition to basic independent functionality inherent to the beacon.
Multiple Simultaneous Space Object Position Determination: The application of static and dynamic scheduled (master/slave) transmission techniques such as TDMA, FDMA, CDMA allow for multiple simultaneous beacons collection, processing, and orbit determination. These techniques allows the system to increase the number of beacons that can be supported by the system and allows the system to simultaneous track multiple and geographically diverse space objects.

The ground sensor may be man portable, and the ground systems may be easy to operate, self-calibrating, inexpensive and, once in place, automated, in order to facilitate worldwide proliferation and deployment. The ground antennas may be relatively small and omnidirectional, without comprising performance in terms of RF gain and directional information on the receive side.

The system may have an overall architecture that may accommodate the different pace of operations associated with a myriad of current space objects and at the same time be sufficiently flexible to accommodate as yet unidentified user needs. In addition, the system may include a communication protocol which mitigates problems arising from co-channel interference.

The system may include scheduled (master/slave) transmission techniques such as TDMA, FDMA, CDMA, or the like, coupled with random retry schemes and a large number of passive ground receiver stations.

The terms “including,” “comprising” and variations thereof, as used in this disclosure, mean “including, but not limited to,” unless expressly specified otherwise.

The terms “a,” “an,” and “the,” as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

While the disclosure has been described in terms of exemplary embodiments, those skilled in the art will recognize that the disclosure can be practiced with modifications in the spirit and scope of the appended claim, drawings and attachment. The examples provided herein are merely illustrative and are not meant to be an exhaustive list of all possible designs, embodiments, applications or modifications of the disclosure.

What is claimed is:

1. A method for position, orbit determination, and unique identification of space objects using an independent, self-powered, command-able beacon that is placed upon a space object and transmits a signal composed of a unique identification code, along with meta-data generated by the beacon and data messages provided by the host space object.

2. The method in claim 1, wherein direct and unique space object identification is achieved by receipt of a beacon's unique identification code and/or data messages from the host space object.

3. The method in claim 1, wherein the method provides for position, orbit determination, and unique identification of space objects even in the event of failed deployment, operational failure, and or space object decommission.

4. The method in claim 1, wherein the method provides for position, orbit determination, and unique identification of non-operational space objects, such as non-functioning spacecraft, rocket bodies, upper stages, rocket engines, and debris.

5. The method in claim 1, wherein data transmissions from on-orbit beacons are received through a worldwide set of networked ground sensors and/or space-based relay satellites.

6. The method in claim 1, wherein a distributed ground sensor network is utilized to spatially locate the beacon transmission, thereby determining the position of the beacon and host space object. The distributed ground sensor network [005] may determine the time, frequency, and duration of the beacon transmission signals [003] for determining the position of the beacon [002] and the host space object [001].

7. The method in claim 1, wherein the beacon unique identification code is used to correlate transmissions received by the distributed ground sensor network.

8. The method in claim 1, where in the data transmission may use one or more static or dynamic communication scheduling techniques in order to allow for multiple and simultaneous beacon transmissions.

9. The method in claim 1, wherein coarse space object position and orbit determination is computed using signal geolocation techniques.

10. The method in claim 1, wherein fine space object position and orbit determination is computed using through fusion of coarse space object position data along with various external space object data sets.

11. A system for tracking space objects, comprising:
a plurality of independent, self-powered, commandable beacons;
a plurality of ground sensors that are distributed worldwide and receive the beacon's transmission;
a centralized command center that provides signal processing, space object position determination, and message generation; and
a set of world-wide distributed ground transmission terminals that send commands to the beacons.

12. The system of claim 11, wherein at least one of the ground sensors utilizes GPS receivers in order to provide accurate ground station positioning and timing.

13. The system of claim 11, wherein at least one of the ground sensors utilizes fixed spatial sampling techniques in order to refine a feasible position solution set.

14. The system of claim 11, wherein at least one of the ground sensors utilizes scanning spatial sampling techniques in order to refine a feasible position solution set.
